(19) United States
(12) Patent Application Publication
(10) Pub. No.: US 2018/0003395 A1
(43) Pub. Date: Jan. 4, 2018

(54) OVEN DOOR AND OVEN COMPRISING AN OVEN DOOR

(71) Applicant: Electrolux Appliances Aktiebolag, Stockholm (SE)

(72) Inventors: Fabienne Reinhard-Herrscher, Rothenburg ob der Tauber (DE); David Joao Machado Martins, Rothenburg ob der Tauber (DE); Nicolas Monroy, Rothenburg ob der Tauber (DE)

(21) Appl. No.: 15/545,436

(22) PCT Filed: Feb. 9, 2016
(86) PCT No.: PCT/EP2016/052669

§ 371 Date: Jul. 21, 2017

(30) Foreign Application Priority Data
Feb. 10, 2015 (EP) 15154457.4

(51) Int. Cl. F24C 15/04; E05B 17/10; F24C 7/08; E05B 1/00; F24C 15/02

(52) U.S. Cl. CPC F24C 15/04; F24C 7/085; E05B 1/0084; E05B 17/10; F24C 15/021

(57) ABSTRACT

The invention relates to an oven door (10) for closing an oven cavity (2) comprising a door glass (11) being at least partially transparent for enabling a user to look into the oven cavity, wherein the door glass (11) comprises at least a first and a second glass pane (11.1, 11.2), the first glass pane (11.1) constituting the outer glass pane and said glass panes being arranged at a distance from one another, wherein an electronic transparent display (12) is arranged in the space between the first glass pane (11.1) and the second glass pane (11.2) in order to provide information to a user in front of the oven door (10) and wherein the oven door comprises heat isolation means for protecting said electronic transparent display (12) against heat radiated by the oven cavity (2).

Generally, the present invention relates to the field of food preparation appliances. More specifically, the present invention relates to an oven door comprising a user interface for displaying information.

### BACKGROUND OF THE INVENTION

Ovens for food preparation are well-known in prior art. Said ovens comprise a base body forming an oven cavity with a cavity opening for receiving the food to be prepared. In addition, the oven comprises a door for closing the cavity opening. The oven door acts as thermal barrier to keep the heat energy in the cavity during operation of the oven. Typically, oven doors are at least partially transparent in order to enable the user to control the food preparation process within the closed cavity. State of the art ovens comprise a user interface usually located above the oven door and attached to the oven base body for providing information to the user, e.g. baking temperature, baking period etc.

German patent application DE 10 2011 007 407 A1 discloses a household appliance comprising a LCD display at the household appliance door.

### SUMMARY OF THE INVENTION

It is an objective of the embodiments of the invention to provide an oven door and an oven with a graphical user interface providing an enhanced visibility of information displayed at said graphical user interface. The objective is solved by the features of the independent claims. Preferred embodiments are given in the dependent claims. If not explicitly indicated otherwise, embodiments of the invention can be freely combined with each other.

According to an aspect of the invention, the invention relates to an oven door for closing an oven cavity comprising a door glass being at least partially transparent for enabling a user to look into the oven cavity, wherein the door glass comprises at least a first and a second glass pane, the first glass pane constituting the outer glass pane and said glass panes being arranged at a distance from one another, wherein an electronic transparent display is arranged in the space between the first glass pane and the second glass pane in order to provide information to a user in front of the oven door and wherein the oven door comprises heat isolation means for protecting said electronic transparent display against heat radiated by the oven cavity. Said oven door is advantageous because information can be displayed at the oven door which provides a greater display area than a display being integrated in a panel above the oven door. By integrating heat isolation means within the oven door, specifically in the door glass, electronic transparent displays may be included in the oven door wherein the heat impact is lowered by said isolation means such that the temperature at the electronic transparent display is below a certain threshold value (which may depend on the technology of the display).

According to embodiments, the oven door comprises a transparent light guide arranged in proximity to, specifically directly behind the electronic transparent display being coupled with a light emitting element in order to provide backlight to the electronic transparent display. More in detail, one or more light guides and associated light emitting elements may be arranged inside the door (i.e. between the first and second glass pane). The one or more light guides may be adapted to receive the light emitted by the light emitting elements, guide the light along the display and uniformly spread said light onto the display (towards the back side of the display). Said light guide may be a transparent light guide, specifically a strip-like light guide or a flat or film-like light guide adapted to distribute the light in two orthogonal dimensions. For example, the light emitting element may be a high power light emitting diode or any other illumination means. According to example embodiments, one or more light guides may be arranged at one or more edges of the electronic transparent display or in the area of the electronic transparent display in order to provide backlight illumination to the electronic transparent display. For example, the one or more light emitting elements may be arranged at one or more edges of the oven door in order to reduce the heat impact to the light emitting elements.

According to embodiments, the back lighting means are planar backlighting means comprising a light guide plate with a pattern configured to spatially distribute the light provided by the light emitting element. Said pattern may be a dot-print pattern or a V-cut pattern. In other words the pattern may comprise an internal pattern using dot-shaped or groove-like contours. Said pattern is adapted to partially reflect the light travelling along the light guide plate. Thereby, an evenly distributed backlighting is achieved.

According to embodiments, the oven door comprises heat insulation means for protecting the back lighting means against heat impact and/or cooling means for cooling the back lighting means. Thereby, the heat impact on the back lighting means is significantly reduced.

According to embodiments, said heat isolation means comprise at least a third glass pane being arranged closer to the oven cavity than the first and second glass panes, the second glass pane being arranged between the first and the third glass pane. Preferably, there is a space between the second and the third glass pane. Said further glass pane may provide an isolation effect resulting in a lower heat impact on the electronic transparent display. Preferably, the second or third glass pane comprises a heat reflective (e.g. IR-reflective) coating which is transparent for light in the visible wavelength range in order to further enhance the isolation effect.

According to embodiments, the heat isolation means comprise a space between two glass panes, said space being filled with an inert gas. Preferably, said space may be located between the oven cavity and the space receiving the electronic transparent display. Said inert gas may be, for example, argon or any other inert gas, for example, molecular nitrogen (N2). By means of said inert-gas-filled space, the heat insulation can be further improved.

According to embodiments, the oven door comprises active and/or passive cooling means for providing an airflow flowing through a space between two glass panes. For example, the airflow may be provided through the space being limited by the first and second glass pane. However, the airflow may also be provided through another space between two glass panes. Also an airflow provided through multiple spaces may be possible. By means of said airflow, the electronic transparent display or a space between two glass panes may be cooled in order to lower the heat impact on said electronic transparent display.

According to embodiments, the electronic transparent display (12) is a transparent liquid display (TLCD), a transparent thin film electroluminescent display (TASEL) or an LED-on-glass display. Said types of displays can be included in the oven door glass without blocking the view through said door glass (and the transparent display) into the oven cavity.

According to embodiments, the LED-on-glass display comprises a plurality of LED elements adhered to the inner surface of the first glass pane, the LED elements being coupled with a control unit via transparent electrical conductive lines. The transparent electrical conductive lines may be formed by printing, sputtering or depositing indium tin oxide (ITO) or carbon- or silver nanotubes ink directly on the first glass pane. Thereby, a highly transparent electronic display is achieved.

According to embodiments, the oven door comprises a control unit for controlling the operation of the electronic transparent display, the control unit being adapted to communicate with an oven control unit. Said oven control unit may be arranged in the base body of the oven. Said control unit may be configured to control the electronic transparent display such that a desired information is displayed at said display.

According to embodiments, the electrical connections or wiring of the electronic transparent display and/or a control unit for controlling the electronic transparent display are arranged behind a non-transparent area of the first glass pane. Said non-transparent area may be constituted by a non-transparent printing on the first glass pane. Thereby, said elements are hidden and not visible by a user being located in front of the oven door.

According to embodiments, the oven door comprises a user control interface, said user control interface being at least partially located in the area of the electronic transparent display, the user control interface being adapted to detect user interactions for controlling the oven. In other words, the user control interface may be also provided at the oven door glass. Thereby, the user not only receives information displayed at the electronic transparent display but is also able to control the oven by touching a certain area or region (e.g. a displayed button) of the door glass.

According to embodiments, the user control interface comprises a touch-sensitive interface of resistive or capacitive type, an infrared touch interface or a touch interface based on surface acoustic waves. By means of said types of user control interfaces touch positions can be detected. Said touch positions may be correlated with certain control information in order to determine the desired user input.

According to other embodiments, the user control interface comprises optical touch and/or gesture recognition means. Said optical touch and/or gesture recognition means make use of infrared transmitters and infrared cameras for determining the touch or approximation position of an object (e.g. the finger of a user). Advantageously, the user input may also be achieved by approximation of an object (e.g. the user's finger) to a certain section of the user control interface, i.e. touching of the user control interface may not be necessary.

According to a further aspect, the invention refers to an oven for preparing food. Said oven comprises an oven cavity and an oven door for closing the oven cavity. The oven door is configured according to the embodiments described above.

According to further embodiments, the oven cavity comprises back lighting means for backlighting the electronic transparent display. The electronic transparent display may be of passive display type, i.e. the information may be displayed by selectively enabling or blocking the transmission of backlight through the electronic transparent display. Said lighting means provide backlight to said electronic transparent display. It is worth mentioning that the second glass pane is transparent at least in the area of the electronic transparent display in order to enable a backlighting by illuminating the oven cavity. Also a combination of back lighting means included in the oven cavity (cavity illumination) with upper-mentioned back lighting means included in the oven door (transparent light guide arranged in proximity to the electronic transparent display coupled with one or more light emitting elements). Such combination may provide an improved back lighting of the electronic transparent display.

According to embodiments, the oven comprises transparent heat insulation means for protecting the back lighting means (included in the oven base body for illuminating the oven cavity) against heat impact and/or cooling means for cooling the back lighting means. Said transparent heat insulation means may be formed by a thermally insulating light guiding element, specifically a thermally insulating lens. Said thermally insulating light guiding element may be provided between the interior of the oven cavity and the one or more light emitting elements (e.g. LEDs) providing said backlighting in order to provide a thermal shielding effect. In order to illuminate the oven cavity, the emitted light is guided through said thermally insulating light guiding element.

In order to achieve a thermal shielding effect of the transparent heat insulation means, the transparent heat insulation means, i.e. the glass lens or glass lens body may comprise a cavity which may be filled with an inert gas. The cavity reduces the heat transfer from the oven cavity to the at least one light emitting element. In this way, a thermal overload of the light emitting element can be prevented. Note that the transparent heat insulation means represent a single optical element that can be placed downstream the light emitting element for both heat shielding and light collecting purposes.

Instead of using inert gas or the like, it may be also possible to evacuate the cavity.

If additional reduction of thermal conduction along the optical path of the transparent heat insulation means is needed, there is the possibility of applying a transparent heat protection coating to the transparent heat insulation means. The protective coating is provided on a side of the transparent heat insulation means opposite to the light emitting element and facing the oven cavity and may comprise mica. As an option, the back lighting means can be coupled to a heat sink or cooling entity. In this way heat, detrimental to the light emitting elements, can be dissipated and thermal overload of the light emitting elements can be avoided. The heat sinks may be of active or passive type or both. An cooling entity may, for example, comprise cooling devices selected from the group comprising fans, chillers, heat conducting devices and Peltier elements, adapted to provide at least one of passive or active cooling.

According to embodiments, the oven cavity comprises at least one buried light emitting element, specifically at least one buried light emitting diode (LEDs) and a light guide for guiding the emitted light into the oven cavity or a thermally insulating light guiding element for providing the emitted light to the oven cavity. Said buried light emitting element may be adapted to illuminate the oven cavity and therefore provide backlight to the electronic transparent display. “Buried” in the present context means that the light emitting elements are not arranged in direct proximity to the oven cavity in order to directly provide light into said oven cavity but are spaced from said oven cavity. Said light guide forms a passage for the light provided by said light emitting element. Due to said spaced arrangement of the light emitting element from said oven cavity, the heat impact to the light emitting element can be significantly reduced. As mentioned before, the at least one light emitting element may be coupled with a heat sink or cooling entity in order to provide a cooling of the light emitting element.

According to embodiments, the light guide may be an elongated light guide element arranged along the oven cavity, for example in a vertical or horizontal direction. The light guide element may be made of transparent material, e.g. glass and may comprise a light input for receiving light emitted by a light emitting element. The light received at the light input may be guided through the light guide element and provided to a light emission surface from which light is emitted into the oven cavity. The light guide element may comprise a volume of prismatic, conical or cylindrical shape.

The light guide element may have flat and/or bow-shaped wall elements. An inner reverse side of the light guide element may comprise a plurality of segmented reflector areas. Preferably, the light guide element is made as a one-piece element. For controlling the emission of light, the reverse side (opposite to the light emission surface) of the light guide element may be designed accordingly. The reverse side may be supplied with said segmented reflector areas. Thus, the major part of the light is reflected from the reverse side to the light emission surface. For this purpose, the surface of the reverse side (as well as of the other wall elements) can be structured or coated to improve the distribution of light. The reverse side can have slants or radii also to improve the distribution of light or to guide the light to certain desired areas. The remainder of the light is emitted directly to the light emission surface.

At least a part of the wall elements of the light guide element may be coated.

A concentration element may be employed between the light emitting element and the light guide element. The concentration element may be part of the socket or of the housing of the light emitting element. The concentration element may also be made of a coating on the light emitting element or its socket. Advantageously, said back lighting means may be adapted to provide a uniform illumination of the electronic transparent display. Said uniform illumination may be achieved by a indirect illumination, i.e. the light emitting element illuminating the oven cavity or the light guiding element or transparent heat insulation means does not or essentially not provide direct light to the electronic transparent display but the light has to be reflected at the interior surface of the oven cavity in order to reach the electronic transparent display.

According to further embodiments, the back lighting means comprise at least one oven cavity wall that comprises an inner surface that consists of a light-reflecting material, such as stainless steel, in particular polished stainless steel, and/or wherein at least part of at least one oven cavity wall inner surface is coated with at least one light-reflective material. For example, a coating with a light reflective material can be a white coating, e.g. a white enamel or a coating with a white polymer, a light grey or any light bright colour enamel or polymer or a coating or enamel comprising light-reflecting particles, for example metal particles, or a reflective steel surface with an essentially transparent enamel or polymer coating. Still preferably, essentially the whole the inner surface of the oven cavity can be adapted to have a highly enhanced reflectiveness for visible light. Thus, according to the invention the backlighting of the electronic transparent display that is arranged between the first and the second oven door glass panes can be effectively enhanced.

In addition, the oven cavity with the afore-mentioned enhanced reflective properties can comprise lightning means with enhanced effectiveness as compared to a conventional oven lamp. For example, the backlighting means can comprise at least one light-emitting diode (LED), in particular and a white light emitting diode for illuminating said oven cavity. Said white light emitting diode may be, for example, a high-power light emitting diode which emits light to the oven cavity. Said emitted light may be reflected at the oven cavity surface. The oven cavity surface may comprise a light reflecting surface. For example, the oven cavity may comprise a reflective coating or may be manufactured in stainless steel. Thereby a homogeneous white background illumination for said electronic transparent display is provided.

According to further embodiments, the electronic transparent display of the oven door is electrically coupled with a control unit and/or power supply arranged in the oven base body via an electrical wiring, an inductive coupling, door contacts and/or wireless transmission means. Also a mixture of wireless and wired connections is possible. For example, the electric power is transmitted using a cable connection whereas the control signal transmission between the oven door and the oven base body is realized by wireless signal transmission, e.g. Bluetooth.

According to a further aspect, the invention relates to a method for operating an oven. The oven comprises an oven cavity and an oven door for closing the oven cavity. The oven door comprises a door glass being at least partially transparent for enabling a user to look into the oven cavity and an electronic transparent display integrated in the oven door as described before. In addition, the oven cavity comprises backlighting means in order to provide backlight illumination to the electronic transparent display. The backlighting means are (automatically) switched on at least when the display is operated, i.e. when information should be provided to an oven user in front of the oven door.

The terms “essentially”, “substantially” or “approximately” as used in the invention means deviations from the exact value by +/−10%, preferably by +/−5% and/or deviations in the form of changes that are insignificant for the function.

### BRIEF DESCRIPTION OF THE DRAWINGS

The various aspects of the invention, including its particular features and advantages, will be readily understood from the following detailed description and the accompanying drawings, in which:

FIG. 1 shows an example schematic view of a baking oven;

FIG. 2 shows an example schematic sectional view of an oven door comprising a stack of door glass panes according to an embodiment;

FIG. 3 shows an example front view of an oven comprising an electronic transparent display in the area of the oven door glass;

FIG. 4 shows a section of the door glass comprising a LED-on-glass display;

FIG. 5 shows an example user control interface for enabling user inputs at the door glass;

FIG. 6 shows an example optical touch and gesture recognition system;

FIG. 7 shows an example schematic sectional view of an oven door comprising backlighting means for backlighting the electronic transparent display; and

FIG. 8 schematically illustrates an electronic transparent display with planar backlighting means including a pattern for reflecting light travelling through a light guide plate.

### DETAILED DESCRIPTION OF PREFERRED EMBODIMENTS

The present invention will now be described more fully with reference to the accompanying drawings, in which example embodiments are shown. However, this invention should not be construed as limited to the embodiments set forth herein. Throughout the following description similar reference numerals have been used to denote similar elements, parts, items or features, when applicable.

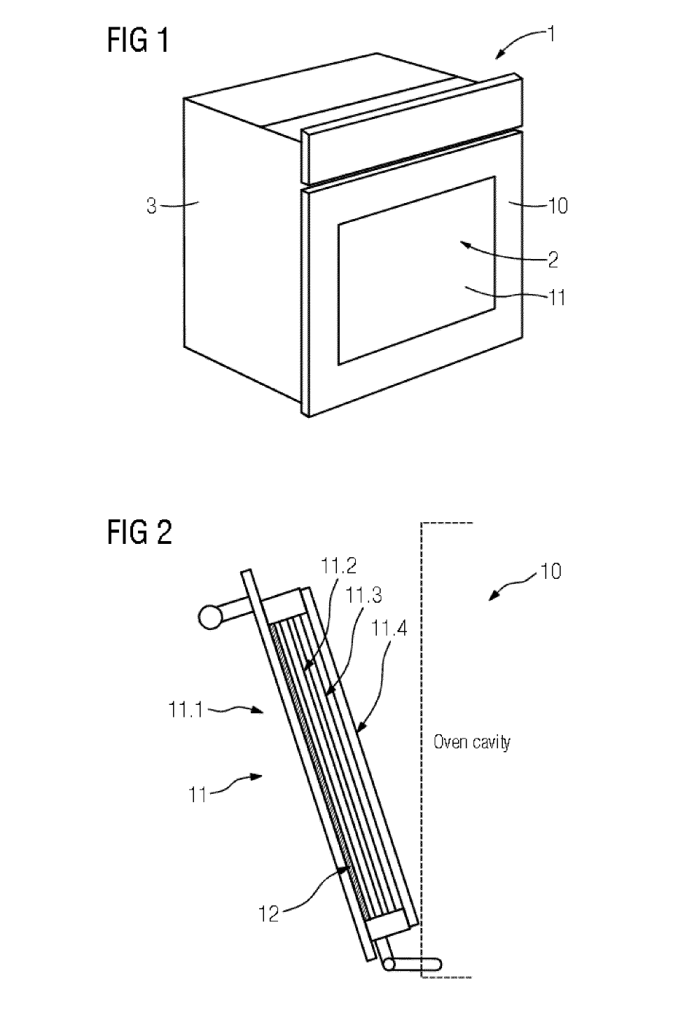

FIG. 1 shows a schematic diagram of a baking oven 1. The baking oven 1 comprises an oven base body 3 with an oven cavity 2 which is adapted to receive the food to be cooked and/or baked. The baking oven 1 further comprises an oven door 10 which can opened in order to place the food into the oven cavity 2 and closed in order to obtain a closed oven cavity 2.

FIG. 2 shows the oven door 10 in closer detail. The oven door 10 comprises a frame or another structural element, for example a door bar and a set of door columns which may border the oven door 10 circumferentially. The frame or set of door bars/door columns 10.2 may build the supporting structural element of the oven door 10, by means of which the oven door is attached to the base body of the oven 1. The oven door 10 further comprises a transparent door glass 11 in order to enable a user to look into the oven cavity 2 during food preparation process without opening the oven door 10. The door glass 11 may be soda-lime glass or safety glass.

The door glass 11 may comprise at least two glass panes, according to the embodiment of FIG. 2 four glass panes 11.1-11.4 which are arranged in a sandwich-like structure. Of course, according to other embodiments, the oven door 10 may also comprise more than four glass panes or less than four glass panes. Said glass panes 11.1-11.4 are arranged at a distance to each other thereby confining a space between them. Preferably, the door glass 11 may comprise at least three glass panes, namely a first glass pane 11.1 forming the outer glass pane (with respect to the oven cavity), a second glass pane 11.2 forming an intermediate glass pane and a third glass pane 11.3 forming the inner glass pane being closer to the oven cavity 2 than the first and second glass pane.

The oven door 10 further comprises an electronic transparent display 12 for displaying graphical information, e.g. alphanumeric characters in the area of the door glass 11. The electronic transparent display 12 is integrated in the sandwich-like structure of said multiple glass panes 11.1-11.4. More in detail, the electronic transparent display 12 is arranged within the space between two adjacent glass panes 11.1, 11.2. Preferably, the arrangement of the electronic transparent display 12 is chosen such that the electronic transparent display 12 is located as far as possible away from the oven cavity 2. In other words, preferably, the electronic transparent display 12 is arranged between the outer most first glass pane 11.1 and the second glass pane 11.2 being adjacent to the first glass pane 11.1.

In order to avoid a significant impact of heat emitted by the oven cavity 2 and therefore keep the temperature of the electronic transparent display 12 below a temperature threshold (said temperature threshold depends on the technology of the electronic transparent display, e.g. below 100° C. for transparent thin film electroluminescent displays (TASEL) or below 50° C. for transparent liquid crystal displays (tLCD)) the oven door 10 comprises heat isolation means. Said heat isolation means may be adapted to shield the electronic transparent display 12 from heat emitted by the oven cavity 2. The heat isolation means may be any means which are adapted to reduce the heat impact to the electronic transparent display 12 while maintaining the optical transparency of the door glass 11.

For example, said heat isolation means may be constituted by at least one more glass pane, namely the third and/or fourth glass pane 11.3, 11.4 being arranged between the oven cavity and the electronic transparent display 12. For further enhancing the heat insolation capabilities, one or more glass panes may comprise a heat-reflective coating.

Alternatively or additionally, there may be a space between the second and third glass pane 11.2, 11.3 and/or between the third and fourth glass pane 11.3, 11.4. Said one or more spaces may be filled with an inert gas in order to improve the heat isolation. The inert gas may be argon or molecular Nitrogen (N2). Said one or more spaces may be hermetically sealed in order to avoid a leakage of said inert gas.

Still alternatively or additionally, the oven door 10 may comprise cooling means for cooling said electronic transparent display 12. The cooling means may comprise a fan or blower for conveying air through the space in which the electronic transparent display 12 is located. The air stream provided by the fan or blower may cool the electronic transparent display 12 thereby avoiding an overheating of said display. Also heat sinks and/or heat pipes may be used for enhancing the cooling effect.

For displaying information at, respectively, in the area of the door glass, different kinds of transparent electronic displays 12 may be used. Common to all said displays is their transparency for light in the visible wavelength range, i.e. a person located in front of the door glass 11 is able to have a look into the oven cavity 2 through the door glass 11 and the transparent electronic display 12 in order to be able to monitor the food to be cooked or baked within the oven cavity 2.

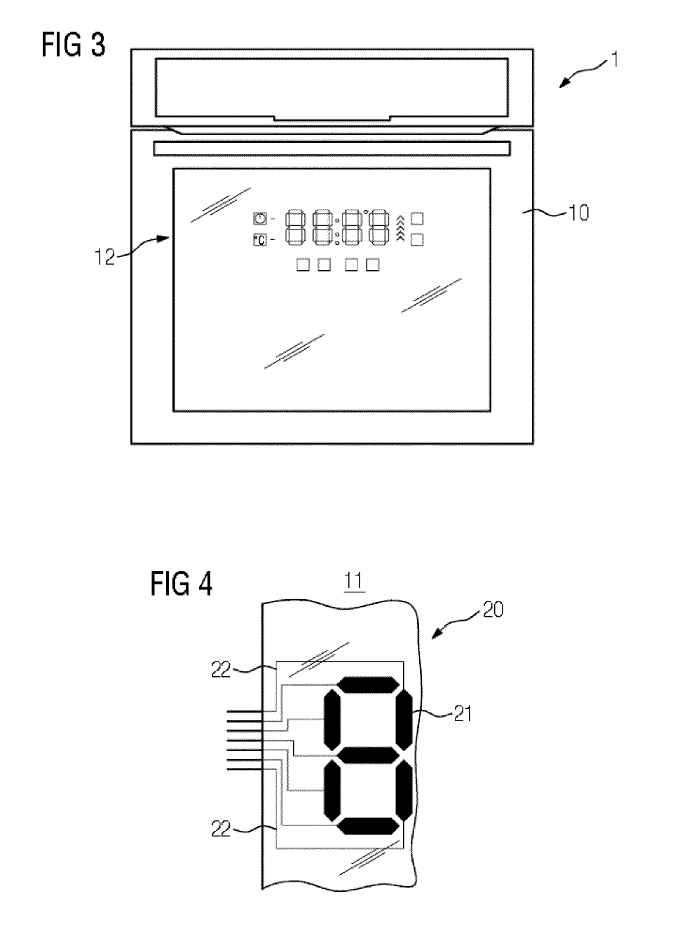

According to a first embodiment, a transparent LCD screen or display may be used for displaying information at the oven door (cf. FIG. 3). The transparent LCD screen may cover the whole transparent area of the door glass 11 or only a section of the transparent area of the door glass 11.

For displaying information, transparent LCDs relay on the fact of blocking or permitting the passage light through the LCD panel. In other words, transparent LCDs are passive display systems, i.e. an external source of illumination is needed to obtain a visible image on said transparent LCD. So, for displaying information, background illumination is necessary. Transparent LCDs differ from typical LCDs on the fact that they do not include any background illumination because when applying background illumination, the transparency of the display is compromised.

According to an embodiment, the oven cavity 2 may be used for providing background illumination. The oven cavity 2 may comprise illumination means for illuminating the oven cavity 2. Said illumination means may illuminate the oven cavity 2 at least in situations when information has to be displayed at the oven door 10. Said illuminated oven cavity 2 may provide the backlighting of the transparent LCD. Preferably, the oven cavity 2 may comprise at least one light emitting diode (LED) providing white light for said oven cavity illumination. The LED may be a high power LED adapted to withstand high temperatures within the oven cavity 2.

In addition, the oven cavity 2 may be used as reflector, i.e. the oven cavity 2 may be adapted to reflect the light emitted by said illumination means. Thus, the oven cavity 2 may comprise a light-reflective surface, e.g. a mirrored surface or stainless steel surface, specifically a polished stainless steel surface. Alternatively, the oven cavity 2 may comprise a highly light-reflective coating (e.g. a white or other light-reflective enamel or coating) in order to ensure an evenly distributed illumination of the oven cavity 2 and therefore an evenly backlighting of the transparent electronic display 12.

According to another embodiment, the electronic transparent display 12 may be constituted by a transparent thin film electroluminescent display (TASEL). In contrary to the transparent LCD display, TASEL is an active display, i.e. the display is adapted to emit light. More specifically, the TASEL comprises a plurality of pixels or segments which may emit light when activated. Thus, there is no need for background illumination and light reflection within the oven cavity. A further advantage of TASEL displays is the ruggedness (for example withstanding temperatures up to 100° C.) and the longer lifespan.

According to another embodiment, the electronic transparent display 12 may be constituted by a LED-on-glass display 20. An exemplary LED-on-glass display 20 is shown in FIG. 4. An LED-on-glass display 20 comprises a plurality of LED devices or LED chips 21 adhered to a glass portion. Said glass portion may be a separate glass portion or the LED devices or LED chips 21 are directly adhered to the oven door glass 11. Preferably, the LED devices or LED chips 21 are directly adhered to the first glass pane 11.1 forming the outer glass pane of the oven door glass 11.

The LED devices or LED chips 21 may be arranged such that alpha-numeric segments are formed. Alternatively, the LED devices or LED chips 21 may form a dot matrix type display. For achieving a transparent display, the LED devices or LED chips are electrically connected by means of transparent electrical conductor traces or wires 22. Said transparent electrical conductor traces or wires 22 may be printed, sputtered or deposited directly on the surface of the glass pane at which the LED devices or LED chips 21 are also adhered to. For example, indium tin oxide (ITO), carbon- or silver-nanotubes inks may be used for forming said transparent electrical conductor traces or wires 22.

The LED-on-glass display 20 may be coupled with a control unit adapted to drive the LED devices or LED chips 21 in order to display information on the door glass 11.

Typically, transparent electronic displays 12 comprise electrical contacts, electrical wires and/or electrical circuits/circuit boards at their edges. In order to avoid the visibility of said elements arranged at the edges, said contacts, electrical wires and/or electrical circuits/circuit boards are arranged behind non-transparent sections of the door glass 11. Preferably, the first glass pane 11.1 comprises a non-transparent section at at least one edge of the glass pane behind which the electrical contacts, electrical wires and/or electrical circuits/circuit boards are hidden. Said non-transparent section may be obtained by a dark printing at the rear side of the glass pane.

In order to control the oven, the oven door 10 may further comprise a user control interface 30. Said user control interface 30 may be included in the door glass 11. By means of the user control interface, the user is able to control the oven 1, for example activate a certain baking program or choose the desired baking temperature. Preferably, the areas, at which the electronic transparent display 12 and the user control interface 30 are provided at the oven door glass 11, may overlap in order to be able to detect touch or approximation of control means (e.g. the finger of a user) in the display area.

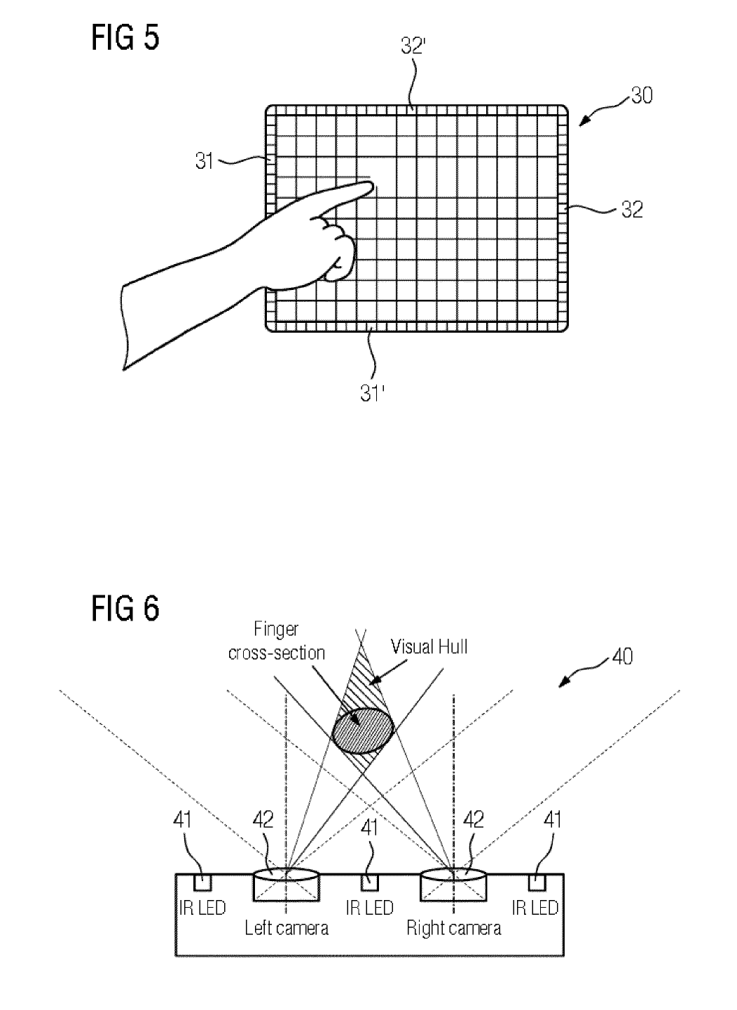

According to an embodiment, the user control interface 30 may be an infrared touch screen. As shown in FIG. 5, multiple infrared emitters 31, 31′ and infrared receivers 32, 32′ are arranged at the edges of the control interface 30. More in detail, a first row of infrared emitters 31 may be arranged in a horizontal direction providing transmission of IR-radiation in a vertical direction and a second row of infrared emitters 31′ may be arranged in a vertical direction providing transmission of IR-radiation in the horizontal direction. Opposite to the rows of infrared emitters 31, 31′, corresponding rows of infrared receivers 32, 32′ may be arranged adapted to receive the IR-radiation transmitted by said infrared emitters 31, 31′. By means of said infrared emitters 31, 31′ and infrared receivers 32, 32′ a detection grid is formed which may be used to detect the position of an object based on the information which optical receiver within the row of optical receivers does not receive IR-radiation because of blocking of IR-radiation by the object.

According to another embodiment, the user control interface 30 may be a touchpad of resistive or capacitive type. For realizing said touchpad, a touch-sensitive layer may be placed behind the door glass 11 or may be integrated within the door glass 11.

Preferably, the touch-sensitive layer may be placed behind or integrated in the first glass pane 11.1 of the door glass 11. In case of a resistive type of touchpad, a control unit coupled with the touch-sensitive layer may be adapted to localize the touch position based on a local change of electrical resistance in the area of the touch-sensitive layer. In case of a capacitive touchpad type, a control unit coupled with the touch-sensitive layer may be adapted to localize the touch position based on a local change of electrical capacitance in the area of the touch-sensitive layer.

Another type of touchpad may comprise a transparent ink printed at an area of the first glass pane 11.1, preferably at the inner side of the first glass pane 11.1. Said ink may comprise electrical properties which change when touching the glass pane in the area of said printing. A control unit coupled with said touchpad may detect and localize said change of electrical properties in order to associate said touch event with a certain control input of the user. Preferably, a touchpad using transparent ink may be used in connection with a LED-on glass display (FIG. 4) because the LED-on-glass technology also uses transparent conductive traces for electrically connecting the LEDs. Said transparent conductive traces may be also printed on the door glass 11 and may therefore be manufactured in the same manufacturing step. However, a touchpad using transparent ink may also be used in conjunction with transparent thin film electroluminescent displays (TASEL).

According to yet another embodiment, the user control interface 30 may include a surface acoustic wave touchpad. The surface acoustic wave touchpad may comprise acoustic wave generator means and acoustic wave receiving means. More in detail, the surface acoustic wave touchpad may comprise at least a first acoustic wave generator for generating acoustic waves in a horizontal direction (x-direction) and a second acoustic wave generator for generating acoustic waves in a vertical direction (y-direction). Similarly, the surface acoustic wave touchpad may comprise at least a first acoustic wave detector for detecting acoustic waves in a horizontal direction (x-direction) and a second acoustic wave detector for detecting acoustic waves in a vertical direction (y-direction). The location of touching the touchpad may be determined based on a variation of surface acoustic waves received by said acoustic wave detectors.

It is worth mentioning that the upper-mentioned types of touch-pads may be transparent for light in the visible wavelength range and said touchpad and the transparent display may be arranged above one another. Thereby it is possible for a user to provide user input by means of the touchpad in the display area. Said touch pads may be of single touch type or multi-touch type.

According to another embodiment shown in FIG. 6, the user control interface may include optical touch or gesture recognition means based on an IR system comprising multiple IR transmitters and multiple IR receivers. An optical touch or gesture recognition system 40 may include multiple infrared transmitters 41, for example IR light emitting diodes. Said IR transmitters 41 may be adapted to transmit light in the IR wavelength spectrum towards the area in front of the door glass 11. In addition, the optical touch or gesture recognition system 40 may comprise multiple IR receivers 42, specifically at least a first and a second camera for receiving IR radiation. For optical touch or gesture recognition the fact is exploited that an object, e.g. the finger of a user, reflects IR radiation transmitted by the IR transmitters 41. Said reflected IR transmission is detected by said IR receivers 42 in order to determine the touch or approximation position of said object. The IR receivers 42 may be coupled with a control unit for determining the touch or approximation position based on the information received from the IR receivers 42 using complex localization algorithms. Said optical touch or gesture recognition system 40 may be preferably used in conjunction with a transparent LCD display because a full coverage of the door glass is achieved without installing any bezels (in case of IR touchscreen, FIG. 5) around the door glass 11.

The electrical connections between the oven door 10 and the oven base body 3 for providing power and control signals to the electronic transparent display 12, respectively, the user control interface may be realized by means of wires or in a wireless way. Also combinations of wired and wireless connections are possible.

The wired connection between the oven door 10 and the oven base body 3 may be realized by means of cablings through the door hinges or electrical connectors at the oven door 10 and the oven base body 3 wherein an electrical contact between an electrical connector at the oven door 10 and a corresponding electrical connector at the oven base body 3 is established when the oven door 3 is closed.

Wireless data transmission may be realized using wireless LAN or

Bluetooth technology. Also proprietary wireless data transmission technologies may be possible. Wireless power transmission may be, for example, realized by means of inductive coupling.

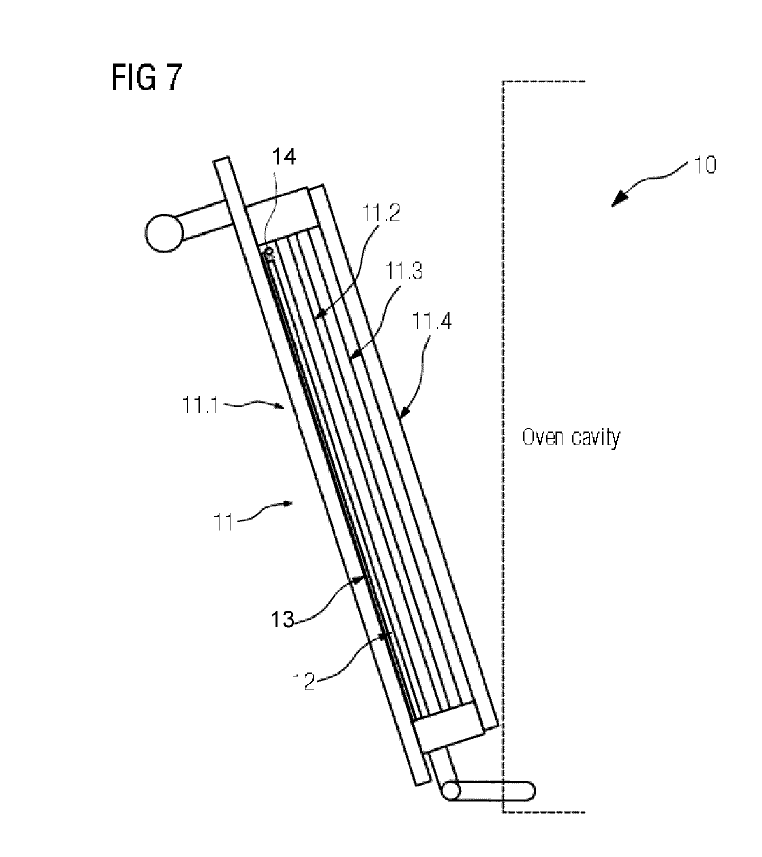

FIG. 7 illustrates a further embodiment of an oven door 10 comprising backlighting means integrated in the interior of the oven door. More in detail, directly behind the electronic transparent display 12, a light guide 13 is provided which may be a strip-like light guide or a planar light guide. A light emitting element 14 is coupled with said light guide 13 in order to transmit light via said light guide. The light guide is adapted to evenly distribute the light across at least a portion of the electronic transparent display 12 in order to provide a backlight to said display 12. It is worth mentioning that said backlighting means included in the oven door may be combined with backlighting means included in the oven cavity, respectively in the oven base body in order to improve the backlighting of the electronic transparent display 12.

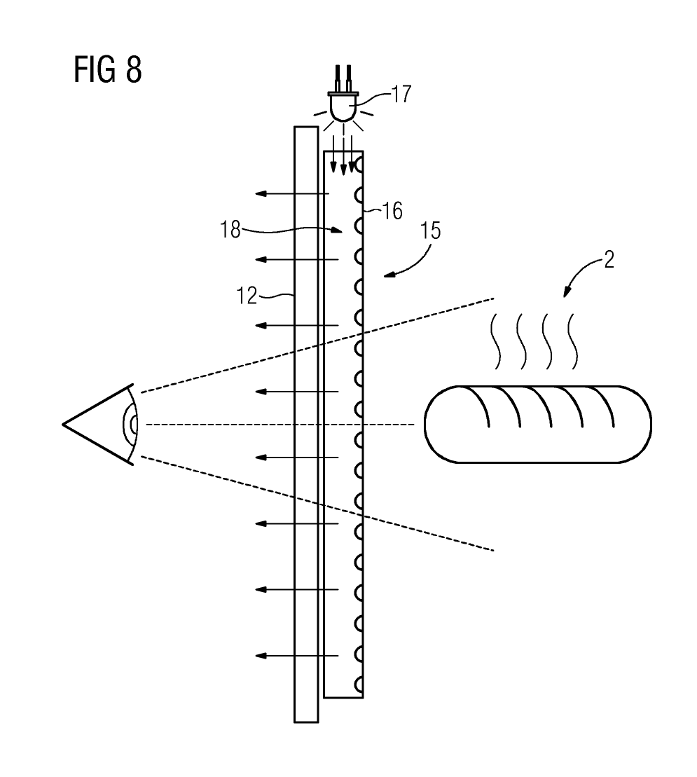

FIG. 8 schematically illustrates an electronic transparent display 12 and planar backlighting means 15 for backlighting said electronic transparent display 12. Said planar backlighting means 15 may comprise a light guide plate 16. Said light guide plate 16 may be arranged in close proximity, specifically directly behind the electronic transparent display 12 (i.e. between the electronic transparent display 12 and the oven cavity 2). The planar backlighting means 15 further comprise multiple light emitting elements 17. Said light emitting elements 17 may be arranged at one or more lateral edges of the light guide plate 16. Preferably, a series of light emitting elements 17 may be arranged at opposite lateral edges of the light guide plate 16.

Said light emitting elements 17 may be adapted to emit light into the light guide plate 16 such that light rays travel through said light guide plate 16 (guided by the step of refractive index between the material of the light guide plate 16 and the surrounding environment). Said light guide plate 16 may comprise an internal structuring or pattern 18 adapted to partially reflect the light guided in the light guide plate 16 in a spatially distributed manner. For example, the pattern may be a dot-print pattern, a V-cut pattern, or any other pattern which achieves a distributed reflection of the light guided in the light guide plate 16. It is worth mentioning that said pattern may be chosen such that the transparency of the oven door 10 in the area of the door glass 11 is maintained. Preferably, the pattern 18 is located at or close to the surface averted from the electronic transparent display 12. The light guide plate 16 may be detachably connected with the electronic transparent display 12, for example, mechanically hold against each other, e.g. by means of a frame or the light guide plate 16 may be glued on the electronic transparent display 12.

Above, embodiments of an oven door according to the present invention as defined in the appended claims have been described. These should be seen as merely non-limiting examples. As understood by a skilled person, many modifications and alternative embodiments are possible within the scope of the invention.

### LIST OF REFERENCE NUMERALS

1 oven

2 oven cavity

3 oven base body

10 oven door

11 door glass

11.1 first glass pane

11.2 second glass pane

11.3 third glass pane

11.4 fourth glass pane

12 electronic transparent display

13 light guide

14 light emitting element

15 planar backlighting means

16 light guide plate

17 light emitting element

18 pattern

20 LED-on-glass display

21 LED device/LED element

22 trace/wire

30 user control interface

31, 31′ infrared emitter

32 infrared receiver

40 optical touch or gesture recognition system

41 IR transmitter

42 IR receiver

1. Oven door for closing an oven cavity, comprising a door glass being at least partially transparent for enabling a user to look into the oven cavity, wherein the door glass comprises at least a first and a second glass pane, the first glass pane constituting the outer glass pane and said glass panes being arranged at a distance from one another, wherein an electronic transparent display is arranged in a space between the first glass pane and the second glass pane in order to provide information to a user in front of the oven door, and wherein the oven door comprises heat isolation means for protecting said electronic transparent display against heat radiated by the oven cavity.

2. Oven door according to claim 1, comprising back lighting means including a transparent light guide arranged in proximity to the electronic transparent display being coupled with a light emitting element in order to provide backlight to the electronic transparent display.

3. Oven door according to claim 2, wherein the back lighting means are planar backlighting means comprising a light guide plate with a pattern configured to spatially distribute the light provided by the light emitting element.

4. Oven door according to claim 2, comprising heat insulation means for protecting the back lighting means against heat impact and/or cooling means for cooling the back lighting means.

5. Oven door according to claim 1, wherein the heat isolation means comprise a space between two glass panes, said space being filled with an inert gas.

6. Oven door according to claim 1, comprising cooling means for providing an airflow flowing through a space between two glass panes. (Currently Amended) Oven door according to claim 1, wherein the electronic transparent display is a transparent liquid display (TLCD), a transparent thin film electroluminescent display (TASEL) or an LED-on-glass display.

8. Oven door according to claim 7, wherein the LED-on-glass display comprises a plurality of LED elements adhered to the inner surface of the first glass pane, the LED elements being coupled with a control unit via transparent electrical conductive lines.

9. Oven door according to claim 1, comprising a control unit for controlling the operation of the electronic transparent display, the control unit being adapted to communicate with an oven control unit.

10. Oven door according to claim 1, wherein electrical connections or wiring of the electronic transparent display and/or a control unit for controlling the electronic transparent display are arranged behind a non-transparent area of the first glass pane.

11. Oven door according to claim 1, comprising a user control interface at least partially located in an area of the electronic transparent display, the user control interface being adapted to detect user interactions for controlling the oven.

12. Oven door according to claim 11, wherein the user control interface comprises a touch-sensitive interface of resistive or capacitive type, an infrared touch interface or a touch interface based on surface acoustic waves.

13. Oven door according to claim 11, wherein the user control interface comprises optical touch and/or gesture recognition means.

14. Oven for preparing food comprising an oven cavity and the oven door according to claim 1 for closing the oven cavity.

15. Oven according to claim 14, wherein the oven cavity comprises back lighting means for backlighting the electronic transparent display.

16. Oven according to claim 15, comprising heat insulation means for protecting the back lighting means against heat impact and/or cooling means for cooling the back lighting means.

17. Oven according to claim 15, comprising at least one buried light emitting element and at least one light guide for guiding emitted light from the light emitting element into the oven cavity or a thermally insulating light guiding element for providing the emitted light to the oven cavity.

18. Oven according to claim 15, wherein the back lighting means comprise at least one oven cavity wall with a light-reflective material or a light-reflective coating and light emitting means for illuminating said oven cavity.

19. Oven according to claim 15, wherein the electronic transparent display of the oven door is electrically coupled with a control unit and/or power supply arranged in the oven base body via an electrical wiring, an inductive coupling, door contacts and/or wireless transmission means.

20. Oven door for closing an oven cavity, comprising a transparent door glass, said door glass comprising a first outer glass pane, a second intermediate glass pane, and a third glass pane located opposite said first glass pane relative to said second glass pane, said first and second panes defining a first space therebetween, said second and third panes defining a second, hermetically sealed space therebetween, an inert gas filling said second space, an infrared-reflective coating that is transparent to visible light applied to an inner surface of at least one of said second glass pane and said third glass pane, an electronic transparent display arranged in said first space and applied to an inner surface of said first glass pane in order to provide information to a user in front of the oven door, a fan for conveying air through said first space for cooling said electronic transparent display, a display control unit for said transparent electronic display being located behind a non-transparent section of said first glass pane provided via printing on a rear side thereof, said display control unit being adapted to communicate with an oven control unit in an oven to which said oven door is installed, a user control interface behind or integrated with said oven door glass and overlapping said electronic transparent display, said user control interface being adapted to detect user interactions in an area adjacent said electronic transparent display for receiving user inputs to control functions of said oven.
